(19) United States
(12) Patent Application Publication
(10) Pub. No.: US 2023/0365437 A1
(43) Pub. Date: Nov. 16, 2023

(54) A Floating Vessel for the Production of Potable Water

(71) Applicant: Barinthus Technologies BV, Brussels (BE)

(72) Inventors: Joern de Wachter, Brussels (BE); Toon Vandamme, Dilsen Stokkem (BE); Patrick Steenacker, Brecht (BE)

(21) Appl. No.: 18/023,872

(22) PCT Filed: Aug. 31, 2021
(86) PCT No.: PCT/EP2021/074004

§ 371 Date: Feb. 28, 2023

(30) Foreign Application Priority Data
Aug. 31, 2020 (LU) 102023

(51) Int. Cl. C02F 1/44; C02F 1/00; B01D 61/02; B63J 1/00; B63J 3/00

(52) U.S. Cl. CPC C02F 1/441; C02F 1/001; B01D 61/025; B63J 1/00; B63J 3/00; C02F 2201/009; C02F 2103/08

(57) ABSTRACT

A vessel (10) comprising a plurality of hulls (15, 15c, 15o) on which is mounted a support (35) with a plurality of solar cells (30) mounted on the support (35) and connected to a plurality of batteries (40) is disclosed. A plurality of osmosis desalination devices (50) is connected electrically to the plurality of batteries (40) and have an input connected to a water supply and an output (54) connected to at least one water storage tank (60).

### CROSS-REFERENCE TO RELATED APPLICATIONS

This application claims benefit of and priority to LU102023. The entire disclosure of LU Patent Application LU102023 is hereby incorporated by reference.

### FIELD OF THE INVENTION

The invention relates a floating vessel for the production of potable water.

### BACKGROUND TO THE INVENTION

Method for the production of potable water from brackish water or saltwater using solar energy are known. For example, International Patent Application No. WO 2005/012180 A2 shows a monohulled sea bound vessel with a fluid media filtration unit and membrane unit located within the single hull of the vessel. The vessel's propulsion system drives the flow of seawater into the media filtration unit and the membrane unit to reduce the level of sodium chloride in the water to desirable specification and thus make the water potable. The vessel is powered by a power plant with auxiliary batteries.

International Patent Application WO 2018/069810 A1 discloses a movable platform for the desalination of sea water. A system comprising a reverse osmosis desalination device is disclosed. The reverse osmosis device is powered by wind turbines, photovoltaic solar cells, or hydraulic turbines. The system further comprises a central control unit. The central control unit is capable of predicting a possible energy consumption of the reverse osmosis device and a predicted power supply by the wind turbines, photovoltaic solar cells, or hydraulic turbines. The control device starts and stops the reverse osmosis device based on the predicted energy consumption and the predicted power supply.

### SUMMARY OF THE INVENTION

This document teaches a floating vessel with one or more hulls on which is mounted a support. In one aspect of the invention the multihull vessel is a trimaran with three hulls. A plurality of solar cells is mounted on the support and is connected to a plurality of batteries. The multihull vessel has further a plurality of osmosis desalination devices connected electrically to the plurality of batteries and having an input connected to a water supply and an output connected to at least one water storage tank. The multihull vessel is able to produce potable water from sea water or brackish water. The water storage tank has an output which is connectable to at least one of a water storage tank on another vessel or to a shore pipe. The other vessel can be used to transport the potable water ashore. In one aspect, the plurality of batteries are mounted within one of the plurality of hulls, for example the central one of the hulls to provide additional stability to the multihull vessel. The plurality of solar cells is mounted at an angle on the support. The water storage tanks are mounted within one of the plurality of hulls, for example in an outer hull.

### BRIEF DESCRIPTION OF THE DRAWING

FIG. 1 shows a top view of a floating vessel for the production of potable water.

FIG. 2 shows a side view of the floating vessel for the production of potable water.

FIG. 3 shows solar panels mounted on the floating vessel.

### DETAILED DESCRIPTION OF THE INVENTION

The invention will now be described on the basis of the drawings. It will be understood that the embodiments and aspects of the invention described herein are only examples and do not limit the protective scope of the claims in any way. The invention is defined by the claims and their equivalents. It will be understood that features of one aspect or embodiment of the invention can be combined with a feature of a different aspect or aspects and/or embodiments of the invention.

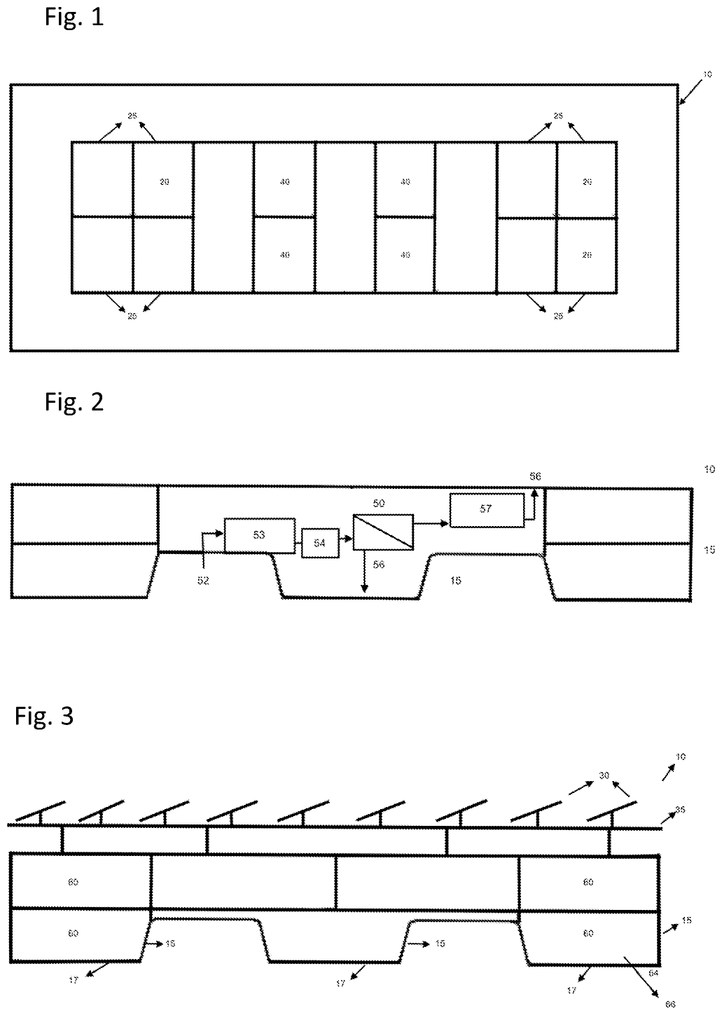

FIGS. 1-3 show a floating vessel 10 in the form of a floating multihull vessel for the production of potable water 20 stored in a plurality of water tanks 25 according to one aspect of this invention. The floating vessel 10 could have a single hull, two hulls (i.e. a catamaran) or three hulls 15, as shown in FIG. 1 (i.e. a trimaran). The trimaran has a central hull 15c and two outer hulls 15o. In principle, the floating vessel 10 could have more than three hulls 15 but this is unlikely to produce any additional benefits. It will be seen that the hulls 15 have a substantially flat bottom 17 which means that the floating vessel 10 can be anchored in shallow waters.

As can be seen in FIG. 3, a support 35 is placed on the three hulls 15 and has an area of around 30 m by 100 m, but this size is not limiting of the invention. The support 35 is a substantially flat support to which a plurality of photovoltaic cells 30 are installed. Examples of the photovoltaic cells 30 that could be used are monocrystalline silicon cells but this is not limiting of the invention. The combination of the support 35 and the multiple hulls 15 lead to a stable floating vessel 10.

A monohulled vessel is, at least at anchor, not as stable as the floating vessel 10 of FIG. 1. The use of the floating vessel 10 means that the position of the plurality of photovoltaic cells 30 on the support 35 remains substantially unchanged, there is little to no movement in the position of the photovoltaic cells 30 due to the floating vessel 10 bobbing up and down in the waves on open sea or otherwise affected by the wind.

The floating vessel 10 can be easily maneuvered into a position to optimize the output of the photovoltaic cells 30. The solar cells 30 are arranged at an angle on the support 35. The angle of the arrangement depends on the latitude at which the floating vessel 10 is located and can be optimized for the sun's position at that latitude. For example, 20-25% in Mediterranean Europe and 0° at the equator.

The photovoltaic cells 30 would have typically an area of 2 m² but this is not limiting of the invention. One of the photovoltaic cells 30 requires around 3.2 m² of surface area on the floating vessel 10 (i.e. a ratio of 1.6 m² of surface area to each 1.0 m² of photovoltaic cell 30). However, this is not limiting of the invention and indeed it is envisaged that the ratio might be reduceable to 1.1. On an exemplary floating vessel 10, there would be around 1000 photovoltaic cells having a total area of 2000 m² on a surface of 3200 m², but this should be reduced over the next few years.

A set of batteries 40 are installed in a battery room on the floating vessel 10 underneath the support 35 and also inside the hulls 15 (see FIG. 1). The set of batteries 40 could be, in one non-limiting example, saltwater batteries which are from the point of view of the environment a good choice for use in the floating vessel 10. The saltwater batteries 40 are typically heavier than other type of batteries, such as Li ion batteries and are able to act as a ballast for the floating vessel 10 to improve further the stability of the floating vessel 10. It will be seen in FIG. 1 that the batteries 40 are stored in the central hull 15c of the multihull vessel 10. This provides the additional stability to the multihull vessel 10. The set of batteries 40 are rechargeable to enable substantially continuous operation of the reverse osmosis desalination devices, as described below.

The saltwater batteries 40 are connected to the plurality of photovoltaic cells 30 and are able to store electrical energy from the production of solar energy in the plurality of photovoltaic cells 30 produced during daytime on the floating vessel 10. It will be appreciated that the set of batteries 40 can be made from any suitable battery technology. The purpose of storing the energy from the plurality of photovoltaic cells 30 in the set of batteries 40 is to allow twenty-four hour (i.e. continuous) production of potable water by solar energy using reverse osmosis desalination devices 50, as described below. Given the fact that the sun only shines during daytime, this storage of electrical energy enables better use of the energy generated by the photovoltaic process.

An example will serve to illustrate this point. Let us suppose that the photovoltaic cell 30 has a capacity (Watt peak) of 430 Watt and is able to supply sufficient energy to run the reverse osmosis desalination devices 50 at an equivalent of 7 hours at full capacity. The photovoltaic cell 30 will produce in other words a maximum of 3.01 kWhr. In such a non-limiting example, the storage capacity of the battery 40 must be at least (24 hours-17 hours)/24 hours of this value to ensure that the reverse osmosis desalination devices 50 can operate substantially continuously (i.e. 24 hours from 24). For one photovoltaic cell 30 of 430 Watt peak, the storage capacity of the corresponding battery 40 should therefore be at least (17/24)*3.010=2.132 kWhr, plus a margin to be calculated depending on the efficiency of the battery and the depth of discharge (DoD) rate/capacity of the battery 40.

A plurality of reverse osmosis desalination devices 50 are installed on the floating vessel 10. The reverse osmosis desalination devices 50 convert seawater (or other brackish water, including river water) into potable water using the energy generated during the day by the plurality of photovoltaic cells 30 and at night from the energy stored in the plurality of batteries 40. This parallel use of the photovoltaic cells 30 and the batteries enables the substantially continuous operation of the reverse osmosis desalination devices 50. This substantially continuous operation of the reverse osmosis desalination devices 50 enables significantly higher efficient operation of the reverse osmosis desalination devices 50.

The reverse osmosis desalination devices 50 have an input 52 with a pre-treatment device 53, such as a filter to remove large impurities, and a pump 54 for inputting sea- or brackish water and an output 58 through a post-treatment device 57 for outputting desalinated water. The reverse osmosis desalination devices 50 have membranes and produce brine 56 as a waste output. This brine 56 can be either as a material for other purposes, including fertilization, or can be diluted on board the floating vessel 10 and released back into the open seas. The post-treatment device 57 includes controls to check whether the water is sufficiently pure and may also include devices for adding chemicals to the water.

The reverse osmosis desalination devices 50 require typically between 1 and 4 kWHr for the production of 1 m3 of potable water. As noted, in the article “Long-term intermittent operation of a full-scale BWRO desalination plant”, Desalination, vol 489, page 114526, (https://doi.org/10.1016/j.desa1.2020.114526), downloaded on 21 Aug. 2020. The reverse osmosis desalination devices 50 cannot be simply switched off and on when energy is available and thus the energy from the set of batteries 40 is used when the sun is not shining and/or the energy supplied from the set of batteries is insufficient to supply the reverse osmosis desalination devices 50. This enables significantly higher efficient operation of the reverse osmosis desalination devices 50, without the need to emit carbon dioxide when there is no sunshine.

The multihull vessel 10 includes water storage tanks 60 connected by pipes to the outputs 54 of the reverse osmosis desalination devices 50 to store the potable water for the potable water to be offloaded by another vessel or to be pumped onto land through a shore pipe 66 when near shore or docked. The water storage tanks 60 will generally be partly filled and the construction of the multihull vessel 10 with the water storage tanks 60 in the outer hulls means that the water storage tanks 60 will remain stable, even when the water storage tanks are only partially filled. Thus, the risk of an upset of the floating vessel during rough weather is reduced as the potable water is not slopping about inside of the water storage tanks 60.

### REFERENCE NUMERALS

10 Floating vessel
15 Hull
17 Bottom
30 Solar Cell
35 Support
40 Saltwater batteries
50 Osmosis desalination devices
52 Input
53 Pre-treatment device
54 Pump
56 Brine
57 Post-treatment device
58 Output
60 Water storage tank
64 Output
66 Shore pipe

1. A floating vessel comprising
one or more hulls on which is mounted a support;
a plurality of solar cells mounted on the support and connected to a plurality of batteries;
a plurality of osmosis desalination devices connected electrically to the plurality of batteries and having an input connected to a water supply and an output connected to at least one water storage tank, wherein the osmosis desalination devices include an input with a pre-treatment device, a pump, and an output through a post-treatment device, and wherein the reverse osmosis desalination devices are configured to operate substantially continuously.

2. The floating vessel of claim 1, wherein the at least one water storage tank has an output connectable to at least one of a water storage tank on another vessel or to a shore pipe.

3. The floating vessel of claim 1, wherein at least one of the plurality of batteries is mounted within one of a plurality of hulls.

4. The floating vessel of claim 1, wherein the plurality of solar cells is mounted at an angle on the support.

5. The floating vessel of claim 1, wherein the at least one water storage tank is mounted within one of the plurality of hulls.

6. The floating vessel of claim 1, wherein the at least one water storage tank is mounted within one of the outer hulls.

7. The floating vessel of claim 1, further comprising at least two hulls.
